(19) United States
(12) Patent Application Publication
(10) Pub. No.: US 2006/0173583 A1
(43) Pub. Date: Aug. 3, 2006

(54) Video player versatile mounting, particularly for vehicles

(76) Inventor: Kenneth Wong, Kowloon (HK)

Correspondence Address: FUESS & DAVIDENAS;Suite 2G, 10951 Sorrento Valley Road, San Diego, CA, 92121-1613, US

(21) Appl. No.: 11/051,680

(22) Filed: Feb. 3, 2005

(51) Int. Cl. G06F 17/00

(52) U.S. Cl. 701/1; 701/49

(57) ABSTRACT

A vehicle 2 has (1) a substantially rectilinear passenger compartment with front, rear, side, top and bottom surfaces plus seats, and (2) an audiovisual system 1 with at least one aperture for receiving media and a screen for showing video, The audiovisual system 1—preferably a Digital Versatile Disk (DVD) player—has both a base portion 11 and a hat portion 12, each of which portions 11, 12 is substantially rectilinear and rectangular, The base portion 11 mounts upon one of its major surfaces to any suitable front, rear, side, top or bottom surface of the passenger compartment so that its aperture for receiving media 121 faces to the front, rear, left, right, up or down, all as is desired and permitted by the mounting, Meanwhile, the hat portion 12 of the audiovisual system 1 mounts upon one of its major surfaces to the remaining major surface of the base portion 11 at a selected 0 degree, 90 degree, 180 degree or 270 degree angular orientation relative thereto so that the screen 131 may face towards any of the front, rear, left side, right side, top or bottom of the passenger compartment, all is desired and permitted. Accordingly, both the spatial orientation of (1) the aperture of the audiovisual system 1 for receiving media 121, and also (2) the screen 131, are independently selected nonetheless to the particular front, rear, side, top or bottom surface of the passenger compartment of the vehicle to which the audiovisual system 1 is mounted.

### BACKGROUND OF THE INVENTION

1. Field of the Invention

The present invention generally concerns the mounting of, and subsequent access to, electronic equipments at diverse spatial positions, particularly within the passenger compartments of vehicles where at least portions of he equipment are both (1) contacted for purpose of control, and also (2) viewed.

The present invention particularly concerns the mounting of a video player, normally a Compact Disk (CD) or Digital Versatile Disk (DVD) player, within the passenger compartment of a vehicle so that (1) access to a slot whereat a CD/DVD may be inserted or extracted, and also (2) the direction and angle at which the viewing screen is located, are both selectable, and independently selectable.

2. Background of the Invention

2.1 Environment of the Invention

The present invention relates generally to an audio/video source that is mounted inside and on an interior panel of a vehicle. More specifically the present invention will be seen to be embodied in an audio/video player unit that is mounted on an interior surface of a vehicle, normally an automobile or a sport utility vehicle (SUV) or a truck.

Modern vehicles are not simply a means of transportation. Automobiles and sport utility vehicles (SUVs), in particular, not only serve to transport people from one place to another but also serve to provide entertainment to the occupants during transit. The entertainment source may be in the form of a simple AM/FM radio, an AM/FM radio with cassette player, an AM/FM radio with CD player, a CD player, a DVD player, a video game console, or any other audio/video source.

Circa 2004 it is common practice to mount electronic apparatus such as television sets, DVD players, and CD players within motorized vehicles such as motor homes, automobiles and sport utility vehicles. Normally, each such apparatus is permanently mounted within the vehicle so as to prevent any unauthorized taking.

Generally the entertainment source is installed inside the dashboard within the center console and within easy reach of the driver and front passenger of an automobile. The bulkier units such as a CD changer and a video cassette player may be installed inside the trunk of an automobile with the controls installed on the center console of the dash board. The rear seat passengers generally cannot reach and control the entertainment source from the back seat of the automobile with the exception of some very high end luxury automobiles that have additional controls at the rear seats. Therefore, the rear seat passengers are generally passive listeners/viewers due to the lack of control of the entertainment source. Furthermore, all occupants of the automobile must listen to or view the same source of entertainment.

2.2 Description of the Prior Art

Diverse mounting systems for vehicular electronic televisions and players are known. Generally all such systems offer some adjustability, especially in the viewing screen, without according such complete and unlimited accessability and access as might provide, for example, that a player could be mounted to a side wall of a vehicle or of a vehicle seat, or that the disk of a media player might be inserted to the forward of the player by a parent driver while the video viewing of the content of the disk transpired to the rearward of the player.

U.S. Pat. No. 6,409,242 to Chang for a flat thin screen T/V monitor automotive roof mount concerns a roof-mounted video display that is rotatable 180 degrees about a first axis between (1) a stored position within a housing and (2) a second position in which the display lies flat against the vehicle roof. The display is also rotatable at least 60 degrees, and preferably 90 degrees, about a second axis that intersects and is substantially perpendicular to the first axis. Each axis includes self-tensioning hinges to hold the display in any position. The display self aligns as it reaches either of the first and second positions so that the display is substantially parallel to the roof. When the display is in the storage position, the display screen faces, and is safely enclosed by, the housing. The invention also includes a number of built-in features to provide passengers with a wide range of entertainment options

United States Patent Application no. 20020190171 to Stock published Dec. 19, 2002, for a console bracket for supporting electronic apparatus concerns a bracket that is used for supporting electronic apparatus and which is adapted for removable connection to the console normally found in vehicles. The bracket includes a tongue part which is connected to the console and a connector which is spaced from the tongue part and which is adapted for connection to the apparatus.

United States Patent Application no. 20040130617 to Tseng published Jul. 8, 2004, for a Vehicle mounted audio/video player unit concerns a video source that is mounted on the roof inside an automobile. The audio/video source may be an AM/FM radio, an AM/FM radio with cassette player, an AM/FM radio with CD player, a DVD player, a video game console, or any other suitable audio/video source. The audio/video source may be attached to the interior roof of an automobile by bolts, sheet metal screws, brackets, or any other suitable means. The roof mounted audio/video source will allow the rear seat passengers to fully and easily control their desired source of entertainment during their occupancy of the automobile without disturbing the driver or the front sear passenger.

United States Patent Application no. 20040189881 to Cook, et al., for a ceiling mounted monitor system concerns a ceiling-mounted monitor system including a housing mounted on a ceiling of a vehicle, a video display monitor mounted on the housing, and a video source mounted in side-by-side relation with the video display monitor.

U.S. Pat. No. 6,125,030 to Mola discloses a vehicle overhead console with flip down navigation unit. The vehicle overhead console assembly includes a console body with a door pivotally attached to the console body. The door is pivotally movable between open and closed positions. A navigation display unit is connected to the door such that the navigation display unit is exposed for viewing by a vehicle occupant when the door is in the open position, and hidden from view when the door is in the closed position. A groove in a substantially U-shaped flexible latch member engages an edge portion of the console body for securing the door in the latched position. The pins on which the door pivots engage a plurality of detents to hold the door in the desired open position.

The principal drawback of the '030 device is the hazard that it poses to passengers. The device swings forward, from a stored position, to a viewing position where the display screen is substantially perpendicular to the roof of the vehicle. Due to the design of the pivots and the obstruction posed by the console body, the screen cannot swing forward any farther than this position. Thus, it poses a significant obstacle for passengers moving within the vehicle. A passenger who is thrown forward during a collision could be seriously injured by striking the screen.

Another drawback of the '030 design is the limited range of viewing positions available for the display screen. The screen may only rotate about one axis, as described. The screen may not be rotated to the left or right to accommodate viewers who are not seated directly in front of the screen. This drawback is especially acute if the display screen is an LED, which can only be seen from a narrow range of angles in front of the screen.

U.S. Pat. No. 5,775,762 to Vitito discloses an overhead console having a flip-down monitor. The console includes an elongated console housing having a leading end and a trailing end, a monitor mounted in the leading end of the console housing, and a compartment for storing a source of video signals.

The '762 design flips downward from a storage position, in which the screen faces the floor of the vehicle, to a viewing position in which the screen faces the back of the vehicle. Like the '030 design, the display may not be rotated farther than this position in which the display is perpendicular to the roof of the vehicle. Thus, the display of the '762 design poses a hazard to passengers moving toward the rear of the vehicle. Neither may the screen be rotated to the left or right, limiting the range of viewing positions for passengers. Furthermore, the display screen, which is typically glass, is always exposed to the interior of the vehicle. Thus, inadvertent contact with the screen is potentially hazardous to passengers even when the display is in a storage position.

Published U.S. Patent no. 20020113451 to Chung I. Chang for a Flat thin screen TV/monitor automotive roof mount shows a vehicle roof mounted video display. The display is rotatable 180 degrees about a first axis, between a stored position within a housing and a second position in which the display lies flat against the vehicle roof. The display is also rotatable at least 60 degrees, and preferably 90 degrees, about a second axis that intersects and is substantially perpendicular to the first axis. Each axis includes self-tensioning hinges to hold the display in any position.

The display self-aligns as it reaches either of the first and second positions. Force acting on the edge of the display as it approaches the roof or the housing causes the display to rotate about the second axis until the display is substantially parallel to the roof. The rotational capability of the display—180 degrees in one direction and between 60 degrees and 90 degrees in another—allows the display to be easily displaced when contacted by a passenger or other object. Thus, the display does not pose a significant hazard to a passenger who inadvertently bumps into it, either casually or during, a vehicle collision.

When the display is in the storage position, the display screen desirably faces, and is safely enclosed by, the housing. The display screen is protected from damage in this position, and passengers are protected from broken pieces of the display screen as might result from a vehicle collision.

The invention also includes a number of built-in features to provide passengers with a wide range of entertainment options. The features include: A television antenna and tuner, A/V input jacks, video-game input jacks, audio-out cables, an FM transmitter cable, and wireless headphone transmitters. options, is convenient to use and poses little risk of harm to passengers.

2.3 Limitations of the Previous Systems

The present invention will be seen to substantially extend the flexibility of mounting media players, particularly video media players and more particularly DVD players, within vehicles.

There are profound limitations on current vehicular electronic equipment positioning and mounting systems that can best be appreciated if the broader history of both (1) these equipments and (2) their mounting within vehicles are considered. It took many, many decades after ‘hi-fi’ was prevalent in concert halls and residences before some vehicle manufacturers commenced to ‘tune’ their audio systems to the passenger cavities of vehicles, much improving the quality of multi-phonic sound sensed by the vehicle occupants. Even now many less well-engineered vehicles simply splay speakers about the vehicle interior in doors and panels and like locations without much consideration to the acoustics thus created.

It is the contention of the inventor of the present invention that presentations from video screens located inside vehicles is presently, circa 2004, at the same formative and immature stage as was the placement of the first radio speakers within automobile dashboards in the 1930's. The manner of locating of video screens, and speakers for listening to multimedia, within many vehicles is as if an installer of a home theater was to come to the purchaser's dwelling house, nail a flat screen high definition television to some wall and ask ‘can you see it?’, set some speakers someplace on the floor and then ask ‘can you hear it?’, and then leave. Perhaps the owner could then (1) see and (2) hear the system, but the positioning of its components could scarcely be considered either optimal, nor in accordance with the owner's personal choices.

Consider now the positional mounting of video equipments, and particularly Digital Versatile Disk (DVD) player equipments, including in the position(s) of their display screens, within a vehicle. What is now, circa 2004, universally transpiring seems to be that the equipments' controls are positioned to be accessible to either the vehicle's driver or it's passengers while the passengers only watch such video display(s) that is (are) positioned either centrally upon the vehicle's ceiling, or within the vehicle's seat backs.

Although such a rigid viewing and listening geometry is arguably suitable for airplanes, such a limited mounting system hardly seems to capture the versatility to which a private vehicle, especially a large sport utility vehicle, may be put by its owner/occupants. For example, what possibilities does such a system present to permit vehicle occupants to view video while they lie recumbent along the long axis of the vehicle? Athwart ships to the vehicle? Are there any rear-facing seats, or seats that convert? What about those viewers that prefer to have the screen close, and others who like to view from a greater distance? Or those who prefer to look up versus those who prefer to look down? And what about those users who prefer earphones that must be plugged or wireless connected to the vehicle's audiovisual system, versus vehicles where all occupants are tolerant of listening via speakers.

Perhaps reconciliation of all these competing requirements cannot be obtained, and all requirements are unlikely to simultaneously satisfied for any large number of vehicle occupants. But simply invariably placing a DVD player atop a central counsel while placing a single video viewing screen upon the vehicle's ceiling in front of the second row of seats certainly does not give the vehicle owner the positional choices he or she would normally enjoy upon having a new wide screen television placed within their home. It is therefore a goal of the present invention to maximize the flexibility in the placement of both the (1) operator interface, and (2) display screen, of an electronic equipment—by way of example a DVD player—that is located within a vehicle.

Accordingly, it is an object of this invention to provide a versatile mounting system for an electronic apparatus, particularly a DVD player, within the interior volume of a vehicle. The system will be seen to include the selfsame electronic apparatus that it serves to locate. Thus the located and mounted electronic apparatus becomes, by features that it will possess, itself a part of the system. Alternatively expressed, the object work piece that is located and mounted by the system of the present invention—the electronic apparatus—is itself a part of the system.

The objective of the system is that (1) every operator control of the apparatus, (2) every point of user insertion and/or extraction of media from the apparatus, and (3) all angles of viewing and/or listening to the apparatus, should be maximally selectable and configurable.

Thus the controls of an electronic apparatus mounted within the interior of a vehicle are, in accordance with the present invention, both easily accessible, and in accordance with the user/owner's personal preferences.

Thus the points at which optical disks, removable hard drives, and like information-bearing media are inserted into, or extracted from, an electronic apparatus mounted within the interior of a vehicle in accordance with the present invention will be prove to be (1) easily accessible, and (2) in accordance with the user/owner's personal preferences.

Thus the points and angles at which pictorial and/or video displays may be viewed, and the locations where optimal separation is obtained between stereophonic or multi-phonic sound channels, from an electronic apparatus mounted within the interior of a vehicle in accordance with the present invention will prove to be easily adjustable, and in accordance with the user/owner's personal preferences.

Still other objects of the present invention will become apparent upon the reading of the following description and the viewing of the accompanying drawings.

### SUMMARY OF THE INVENTION

The present invention relates to a system for mounting an electronic equipment, particularly including a DVD player having a video display screen, on the inside surfaces of a vehicle, including but not limited to the classic position on the roof of the vehicle. More specifically, the present invention contemplates a vehicular equipment mounting system that incorporates a wide range of options in (1) spatially positioning each of (1a) controls, (1b) apertures into which media may be entered, and (1c) a viewing screen, of the equipment, so that (2) the equipment is convenient to (2a) control, with optimal (2b) viewing and (2c) listening, meanwhile to (3) posing but little risk of harm to passengers in the event of an accident.

In simplest terms, when installed as an aftermarket product in an existing vehicle, a DVD player or like equipment mounted in accordance with the present invention can be readily and conveniently put pretty much anywhere within the vehicle that the owner desires (as may be limited by local law and ordinance) so that subsequent control, viewing and listening may each transpire completely as desired.

1. An Audiovisual System, or DVD Player, Mounted to a Vehicle

In one of its aspects the present invention is embodied in a vehicle having (1) a substantially rectilinear passenger compartment with front, rear, side, top and bottom surfaces plus seats, and (2) an audiovisual system with at least one aperture for receiving media and a screen for showing video.

This vehicle's (1) passenger compartment and (2) audiovisual system are jointly characterized in that (1) a substantially rectilinear base portion of the audiovisual system == having two co-parallel major surfaces and at least four side surfaces one of which side surfaces contains the aperture for receiving media ==, is mounted upon one of its major surfaces to any of the front, rear, side, top or bottom surfaces of the passenger compartment so that the aperture selectively faces to the front, rear, left, right, up or down as the compartment surface to which mounting is effected otherwise permits. ‘Otherwise permits’ means only that the selectively positioned aperture cannot, quite logically, face directly into, or diametrically opposite to, its mounting.

Meanwhile (2) a substantially rectilinear hat portion of the audiovisual system—having on one major surface a selectively positioned screen—is mounted upon the other of its major surfaces to the remaining major surface of the base portion. This mounting is again at a selected orientation so that the screen may face towards any of the front, rear, left side, right side, top or bottom of the passenger compartment as the mounting otherwise permits. (As before, ‘otherwise permits’ means only that the selectively oriented hat portion cannot, quite logically, have its viewing screen facing directly into, or diametrically opposite to, its mounting to the base portion.)

By this construction, and this coaction, both the spatial orientation of (1) the aperture of the audiovisual system for receiving media, and also (2) the screen of the audiovisual system, are independently selected. This is true nonetheless to the front, rear, side, top or bottom surface of the passenger compartment of the vehicle to which the audiovisual system is mounted. In fact, still other parts of the audiovisual system, such as its controls, are co-located with the (1) base portion of the (2) hat portion, and are thus themselves selectively located and positioned in accordance that the (1) base and (2) hat portions are so selectively located and positioned.

The vehicle's system is preferably further characterized in that the substantially rectilinear base portion of the audiovisual system has a slot aperture for receiving an optical disk media, and it is this slot aperture that is susceptible of being selectively positioned so as to face front, rear, left, right, up or down (as the compartment surface to which mounting of the base portion is effected otherwise permits).

This substantially rectilinear base portion of the audiovisual system having a rectangular aperture may, alternatively or additionally to the receipt of a DVD, also be for receiving an hard disk drive (HDD), and a rectangular aperture for this HDD is also selectively positioned facing front, rear, left, right, up or down (as the compartment surface to which mounting of the base portion is effected otherwise permits).

The vehicle's system is preferably still further characterized in that the substantially rectilinear hat portion of the audiovisual system has a pivoting display screen, and it is this display screen that pivots so as to be positioned facing front, rear, left, right, up or down as the mounting of the hat portion otherwise permits.

In still greater detail it may be considered that the substantially rectilinear base portion of the audiovisual system has and defines imaginary X and Y axis; and that the substantially rectilinear hat portion of the audiovisual system mounts to this base portion so that the screen faces in any of the directions of the (I) +X axis, 0 degrees, (ii) +Y axis, 90 degrees, (iii) −X axis, 180 degrees, or (iv) −Y axis, 270 degrees. Meanwhile, the base portion itself is mountable to any suitable surface of the vehicle—which surfaces are most commonly vertical or horizontal both parallel and perpendicular to the long axis of the vehicle—at any angle, but most commonly at 0, 90, 180, or 270 degrees, Combining both these versatile mountings accords considerable flexibility as to where, in particular, the viewing screen of the DVD player is positioned.

2. A Vehicular Audiovisual System

In another of its aspects the present invention may be considered to be embodied in a vehicular audiovisual system having (1) a substantially rectilinear base portion—with two co-parallel major surfaces and at least four side surfaces one of which side surfaces contains the aperture for receiving media—mounted upon one of its major surfaces to any of front, rear, side, top or bottom surfaces of the passenger compartment of a vehicle so that the aperture faces to the front, rear, left, right, up or down as the surface of the passenger compartment to which mounting is effected otherwise permits. Meanwhile, and further, (2) a substantially rectilinear hat portion—with one major surface presenting selectively positioned screen—is mounted upon the other of its major surfaces to a remaining major surface of the base portion at a selected orientation so that the screen faces towards any of the front, rear, left side, right side, top or bottom of the passenger compartment as the mounting otherwise permits.

By this ‘stacked’ construction, and this coaction, the spatial positions and orientations of both (1) the spatial orientation of the aperture of the audiovisual system for receiving media containing content, and also (2) the screen of the audiovisual system, are independently selected during the mounting of the audiovisual system in both of its base and its hat portions.

The base portion preferably includes (1) a substantially square base plate, (2) metal tapping screws attaching the base plate to a front, rear, side, top or bottom surfaces of the passenger compartment of the vehicle, and (3) a substantially rectilinear electronics assembly attached upon one of its two major surfaces to the substantially square base plate at any of 0, 90, 180 or 270 degrees angular orientation relative thereto.

Meanwhile, the hat portion including on one major surface a substantially rectilinear display screen is attached upon the other of its two major surface to the substantially rectilinear base portion at any of 0, 90, 180 or 270 degrees angular orientation relative thereto. The display screen is preferably hinged for tilting relative to the hat portion.

3. A Method of Assembling a Vehicular Audiovisual System

In still yet another of its aspects the present invention may be considered to be embodied in a method of assembling a vehicular audiovisual system having (I) at least one aperture for receiving media and also (ii) a display screen for showing video to, and within, a substantially rectilinear passenger compartment of a vehicle.

The preferred method starts with (1) first-orienting a substantially rectilinear base portion of the audiovisual system == having two co-parallel major surfaces and at least four side surfaces one of which side surfaces contains the aperture for receiving media—so that one of its two major surfaces is adjacent to some one of the front, rear, side, top or bottom surfaces of the passenger compartment, and so that the aperture faces to the front, rear, left, right, up or down as the compartment surface to which mounting is effected otherwise permits.

The method then continues with (2) second-orienting a substantially rectilinear hat portion of the audiovisual system—having on one of two major surface a tilting screen—so that the other one of its major surfaces is both adjacent to the remaining major surface of the base portion, and at an orientation relative thereto so that the screen may face towards any of the front, rear, left side, right side, top or bottom of the passenger compartment (as the mounting otherwise permits).

Finally, the method concludes with (3) collectively securing the hat portion upon the base portion to some one of the front, rear, side, top or bottom surfaces of the passenger compartment.

By these steps both the spatial orientation of (1) the aperture of the audiovisual system for receiving media, and also (2) the display screen of the audiovisual system, have been independently selected respectively during the first-orienting and during the second-orienting, This selective orientation transpires nonetheless to the particular front, rear, side, top or bottom surface of the passenger compartment of the vehicle to which the audiovisual system is mounted.

The collectively securing preferably transpires by bolting.

### BRIEF DESCRIPTION OF THE DRAWINGS

FIG. 1 is a pictorial view showing a base plate component, only, of the system of the present invention mounted to a typical roof location within a vehicle.

FIG. 2 and FIG. 3 are diagrammatic views illustrating how a base portion of the present invention may be placed at either of a typical, respectively 0 degrees and 180 degrees, angles relative to the base plate component of the present invention previously seen in FIG. 1.

FIG. 3 is a exploded diagrammatic view illustrating the complete system of the present invention as applied to the mounting (normally to a vehicle) of an electronic equipment (normally a DVD player) which equipment has both one or more slots for receiving audiovisual media (normally a DVD) and a display screen.

### DESCRIPTION OF THE PREFERRED EMBODIMENT

Overhead consoles for vans and other large vehicles are well known One common type of overhead console contains a video display screen and other components to keep passengers entertained on long journeys. These consoles are generally mounted near the center of the transverse axis of the vehicle with the display screen facing the rear. However, current overhead consoles for video display screens include features that make them either unsafe or inconvenient to use, or both.

The present invention relates to a system for mounting an electronic equipment, normally a DVD player having a video display screen, to almost any sufficiently strong and stable inside surface of a vehicle. Suitable surfaces include, but are not limited to, the vehicle's roof, center counsel, sidewalls and/or seat backs. More specifically, the present invention provides a vehicle mounted video display that incorporates a wide range of entertainment options, is convenient to use and poses little risk of harm to passengers during and accident.

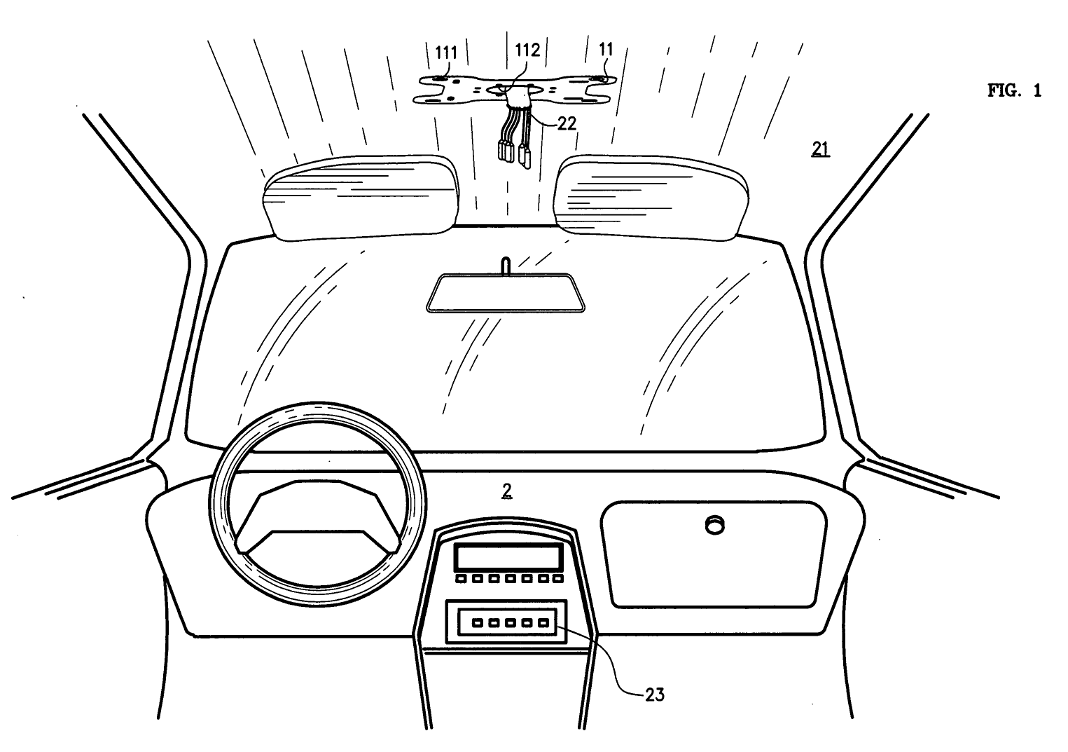

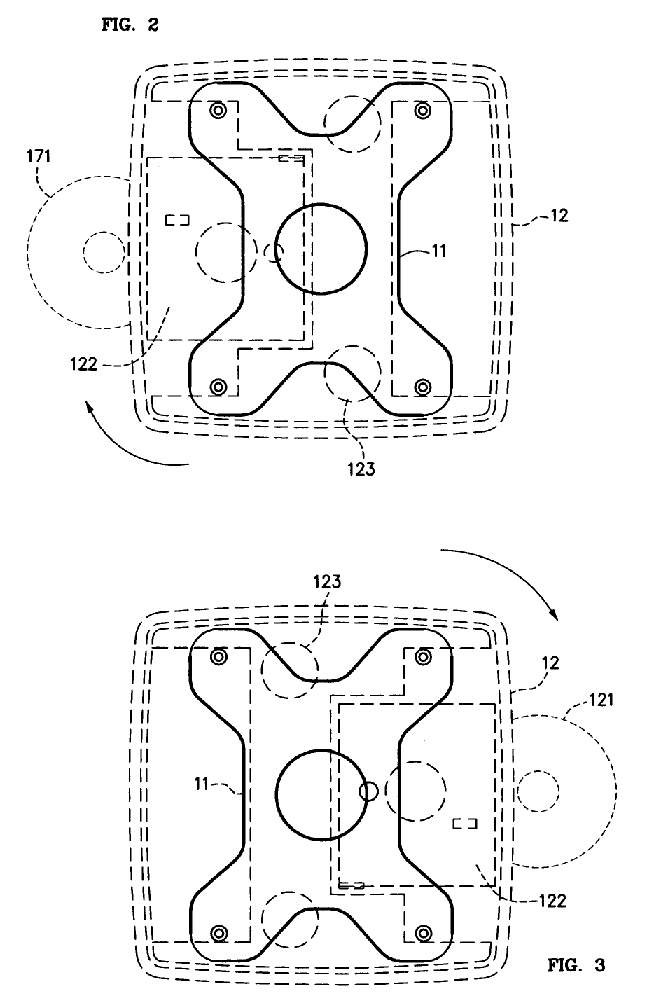

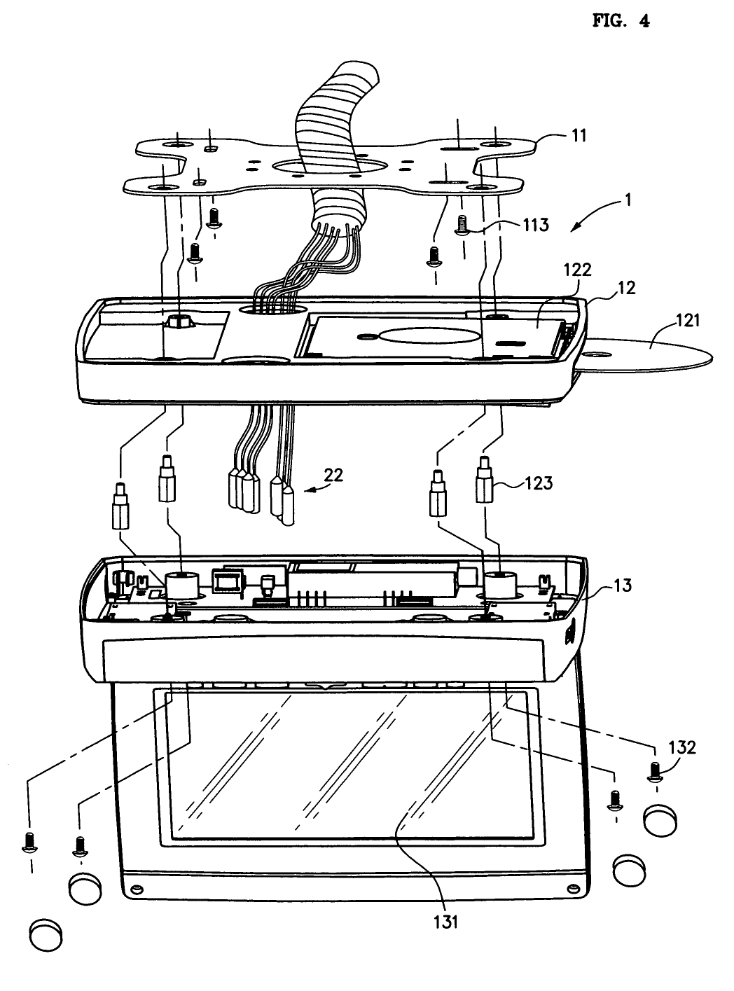

Although the most substantial view of the system of present invention is shown in FIG. 3, fist shown in FIG. 1 is a base plate component 11 of the system of the present invention. This base plate component 11 is shown mounted to a typical roof location 21 within a vehicle 2 (neither roof 21 not vehicle 2 are part of the present invention), but it could be likewise mounted to any reasonably flat surface of the vehicle, even the vehicle's floor. This base plate component 11 may be observed to be substantially square—as may be again observed in subsequent FIGS. 2 through 4. The base plate component 11 is normally circularly symmetric, although this is not demanded so long as the mounting holes 111—also seen in FIGS. 2-4—by which further assemblies are mounted are equally spaced from one another in, most preferably, the form a geometric square. (Mounting holes in the pattern of a triangle do not offer sufficient mounting versatility, as may be later understood. Meanwhile, distributing the mounting holes in the pattern of a pentagon or heptagon proves awkward, and in the pattern of a hexagons or octagon is arguably excessive,)

The base plate component 11 preferably has a central aperture 112 through which proceed wires and connectors 22 (also not part of the present invention). These wires and connectors 22 are the basis by which power is communicated through the base plate component 11, and to other active assemblies of the system 1 that is most completely seen in FIG. 4. Additionally, these wires and connectors 22 pass signals to other electronic assemblies and sub-assemblies including, most commonly, speakers as may be concealed within or behind various interior surfaces of the vehicle 2 (as is common in vehicular sound systems), The wires and connectors 22 may also connect to remote control panels, such as may be located at instrument board and dash panel 23 (not part of the present invention). Note that the central location of the aperture 112, and the wires and connectors 22 passing through this aperture, make that the wires and connectors 22, which are rotationally flexible, may be readily attached to further, active, system portions and assemblies—best seen in FIGS. 2-4—at any desired angular orientation of these assemblies.

Diagrammatic views illustrating how a next, base portion 12, of the present invention may be placed at either of two typical angles—respectively called 270 degrees and 90 degrees—relative to the base plate component 11 (previously seen in FIG. 1) are respectively shown in FIGS. 2 and 3. The base portion 12 contains a slot by which removable media 121 may be accepted or removed. This removable media 121 is illustrated to be a CD, or DVD, 121 that is received into, or removed from, a CD, or, more preferably, a DVD player 122 in each of FIGS. 2-4. The base portion 12 thus has an appreciable thickness (to accommodate this player 122, and other electronics), as is most clearly illustrated in FIG. 4.

Notably, the base portion 12 can alternatively, or additionally, accommodate a pluggable hard disk drive (HDD) (not shown). When both a CD/DVD shot and a slot for a removable HDD are used, then the slot for the HDD may be upon (1) the same surface, (2) a side surface, or (3) an opposite surface, to the surface upon which is the slot for the CD/DVD 122. This means the hard disk drive (not shown) may be inserted and plugged (1) on the same surface, or (2) on a side surface, or even (3) on an opposite surface, to that surface of the base portion 12 to which the CDs/DVDs are inserted and subsequently captured by a disk rotating and reading mechanism.

Particularly in FIGS. 2 and 3, the base portion 12, illustrated in dashed line, is mounted so that the illustrated CD/DVD player 122 is at one of two opposite positions, respectively referred to as the 270 degree and the 90 degree positions. The CD/DVD player 122 could alternatively be mounted at 0 degree or 180 degree positions (not shown). Meanwhile, the base plate component 11, and thus also, the base portion 12 will be understood to be susceptible of being mounted upon any suitable surface of the vehicle 2 (not just the ceiling shown in FIG. 1), and at any angle upon this surface (and not just square to the ceiling of generally rectilinear passenger compartment of the vehicle as is shown in FIG. 1). It may thus be understood that—by judicious mounting of both the base plate component 11, and, relative thereto, the base component 12—the CD/DVD 122 (or, equivalently a pluggable hard drive, not shown) may become accessible from virtually any direction within the passenger compartment of the vehicle 2. The slot for disk 121 within the CD/DVD player 122 may be directed to the fore or to the rear of the vehicle's passenger compartment, to the left of the right side of the vehicle, or even towards the top or the bottom of the vehicle.

It will next be understood by reference to the exploded view of FIG. 4 that the versatile positional mounting of the base portion 12 within the system 1 of the present invention does not limit an equally versatile mounting of a screen 131 of a screen portion 13. Namely, the direction in which a CD/DVD 122 may be entered into (extracted from) a CD/DVD player 122 of the base portion 12 does neither limits nor constrains an equally versatile mounting of a display screen assembly 13 and its attached display screen 131. The net mounting may be so that the display screen 131, as tilted, may face to the forward, to the rearward, to the left or to the right, and even, more rarely, up or down within the passenger compartment of the vehicle 2.

Referring now to FIG. 4 for the details of the preferred construction, the base plate component 11 is attached to a suitable surface (not shown) of the vehicle 2 by sheet metal screws 113, and the base portion 12 is then attached to this base plate component 11 by screw posts 123, all as has been explained. Clearly the base portion 12 could be directly attached to the vehicle 2 without the use of any base plate at any desired orientation, but the use of a base plate 11 is preferred for ease in the orderly successive affixation of components.

Continuing, the relatively square screen portion 13 is attached to the base portion by screws 132 that thread bores within the screw posts 123. The screen portion 13 may be so mounted to the base portion 12 at any of 0 degrees, 90 degrees, 180 degrees, or 270 degrees relative thereto. Note that the wires and connectors 22, first seen in FIG. 1, are at least in part passed through a hole 123 in the base portion 12 so as to connect to electronics within the screen portion 13. That some of these wires and connectors 22 might also attach to the base portion 12, or that some electrical connection might be made by further wires and connectors between the base portion 12 and the screen portion 13, does not detract from the present invention. It is only necessary that the flexibility of the electrical connections support the versatility of the mechanical connections, and this is readily realized in the system 1 of the present invention where wire routing is relatively central, and is thus relatively unaffected by the angular orientation of connected portions/assemblies.

Continuing in FIG. 4, the screen 131 is part of, and is affixed to the screen portion 13. Preferably by a hinged connection (not shown). The screen 131 normally tilts under manual forces between a 0 degrees, or closed, position and a position of approximately 120 degrees about its hinge axis. The screen 131 normally hinges and tilts about a hinge/tilt axis that is at the opposite edge of the screen portion 13 to the location of a viewer of the screen 131, and along a long edge of the screen portion 13, which is typically rectangular in, The screen 131 is most preferably of a 16:9 (HDTV) ratio. This location of the hinge, or tilt, axis is thus established by factory assembly of the screen 131 to the screen portion 13.

However, it is normally possible to order a system 1 wherein this assembly, and this hinging/pivoting, is opposite to the situation illustrated in FIG. 4. Namely, the screen 131 can be arranged to hinge/tilt from an edge of the screen portion 13 that is closest to the viewer, making that this screen 131 remains exposed when it is in the folded closed, or storage, position. This exposure is without consequence, as the display screen 131 is durable, and no more likely to be damaged when stored than when in use for viewing. Indeed, it may even continue to show video when in the stowed and flat position. When it is remembered that the entire system 1 may be mounted to a side wall of the vehicle 2, the concept that the display screen 131 should be continuously visible, and viewable even when closed to the screen portion 13, makes more sense.

Notably the viewing screen 131 has but little mass, while the remaining part of the screen portion 13, and also the base portion 12, of the system 1 have in height above the surface to which they are mounted but a low profile. In the event of a severe accident to the vehicle, the viewing screen 131 is likely the only part of the system 1 to be contacted by occupants of the vehicle, and it has each of (1) a low mass, (2) rounded (non-sharp) contours, and (3) limited break-away force, making it less likely to cause injury during any contact with occupants of the vehicle.

In accordance with the preceding explanation, variations and adaptations of the vehicular sound system connector in accordance with the present invention will suggest themselves to a practitioner of the mechanical mounting arts, especially as applied to electronic equipments that are also electrically connected, and especially within vehicles. For example, the portions, and the configuration of their mounting bolt holes, need not have been square but could be, for example, hexagonal. For example, an intermediate, rotational, bracket could be further interposed between the screen assembly 13 and its display screen 131—although this scarcely seems necessary.

In accordance with these and other possible variations and adaptations of the present invention, the scope of the invention should be determined in accordance with the following claims, only, and not solely in accordance with that embodiment within which the invention has been taught.

What is claimed is:

1. A vehicle having
a substantially rectilinear passenger compartment with front, rear, side, top and bottom surfaces plus seats, and
an audiovisual system with at least one aperture for receiving media and a screen for showing video,
CHARACTERIZED IN THAT
a substantially rectilinear base portion of the audiovisual system having two co-parallel major surfaces and at least four side surfaces one of which side surfaces contains the aperture for receiving media, is mounted upon one of its major surfaces to any of the front, rear, side, top or bottom surfaces of the passenger compartment so that the aperture selectively faces to the front, rear, left, right, up or down as the compartment surface to which mounting is effected otherwise permits; while
a substantially rectilinear hat portion of the audiovisual system having on one major surface a selectively positioned screen is mounted upon the other of its major surfaces to the remaining major surface of the base portion at a selected orientation so that the screen may face towards any of the front, rear, left side, right side, top or bottom of the passenger compartment as the mounting otherwise permits;
wherein both the spatial orientation of the aperture of the audiovisual system for receiving media, and also the screen of the audiovisual system, are independently selected nonetheless to the front, rear, side, top or bottom surface of the passenger compartment of the vehicle to which the audiovisual system is mounted.

2. The vehicle according to claim 1 FURTHER CHARACTERIZED IN THAT
the substantially rectilinear base portion of the audiovisual system has a slot aperture for receiving an optical disk media, and it is this slot aperture that is selectively positioned so as to be facing front, rear, left, right, up or down as the compartment surface to which mounting of the base portion is effected otherwise permits.

3. The vehicle according to claim 1 FURTHER CHARACTERIZED IN THAT
the substantially rectilinear base portion of the audiovisual system has a rectangular aperture for receiving an hard disk drive, and it is this rectangular aperture that is selectively positioned so as to be facing front, rear, left, right, up or down as the compartment surface to which mounting of the base portion is effected otherwise permits

4. The vehicle according to claim 1 FURTHER CHARACTERIZED IN THAT
the substantially rectilinear hat portion of the audiovisual system has a pivoting screen, and it is this screen that pivots so as to be positioned facing front, rear, left, right, up or down as the mounting of the hat portion otherwise permits

5. The vehicle according to claim 1 FURTHER CHARACTERIZED IN THAT
wherein the substantially rectilinear base portion of the audiovisual system has and defines imaginary X and Y axis; and
wherein the substantially rectilinear hat portion of the audiovisual system mounts to this base portion so that the screen faces in any of the (I) +X axis, 0 degree, (ii) +Y axis, 90 degree, (iii) −X axis, 180 degree, or (iv) −Y axis, 270 degree, directions.

6. A vehicular audiovisual system comprising:
a substantially rectilinear base portion, having two co-parallel major surfaces and at least four side surfaces one of which side surfaces contains the aperture for receiving media, mounted upon one of its major surfaces to any of front, rear, side, top or bottom surfaces of the passenger compartment of a vehicle so that the aperture faces to the front, rear, left, right, up or down as the surface of the passenger compartment to which mounting is effected otherwise permits; and
a substantially rectilinear hat portion having on one major surface a selectively positioned screen and mounted upon the other of its major surfaces to a remaining major surface of the base portion at a selected orientation so that the screen faces towards any of the front, rear, left side, right side, top or bottom of the passenger compartment as the mounting otherwise permits;
wherein both the spatial orientation of the aperture of the audiovisual system for receiving media, and also the screen of the audiovisual system, are independently selected during mounting of the audiovisual system in both its base and its hat portions.

7. The vehicular audiovisual system according to claim 6 wherein the base portion comprises:
a substantially square base plate;
metal tapping screws attaching the base plate to a front, rear, side, top or bottom surfaces of the passenger compartment of the vehicle;
a substantially rectilinear electronics assembly attached at a major surface to the substantially square base plate at any of 0, 90, 180 or 270 degrees angular orientation relative thereto.

8. The vehicular audiovisual system according to claim 7 wherein the hat portion comprises:
a substantially rectilinear screen mount attached at a major surface to the substantially rectilinear base portion at any of 0, 90, 180 or 270 degrees angular orientation relative thereto; and
a screen hinged for tilting relative to the screen mount.

9. A method of assembling a vehicular audiovisual system having (I) at least one aperture for receiving media and also (ii) a screen for showing video to, and within, a substantially rectilinear passenger compartment of a vehicle, the method comprising:
first-orienting a substantially rectilinear base portion of the audiovisual system having two co-parallel major surfaces and at least four side surfaces one of which side surfaces contains the aperture for receiving media so that one of its major surfaces is proximate to some one of the front, rear, side, top or bottom surfaces of the passenger compartment and so that the aperture faces to the front, rear, left, right, up or down as the compartment surface to which mounting is effected otherwise permits; and then
second-orienting a substantially rectilinear hat portion of the audiovisual system having on one major surface a selectively positioned screen so that the other of its major surfaces is proximate to the remaining major surface of the base portion at an orientation where the screen may face towards any of the front, rear, left side, right side, top or bottom of the passenger compartment as the mounting otherwise permits; and then
collectively securing the hat portion upon the base portion to the one of the front, rear, side, top or bottom surfaces of the passenger compartment;
wherein both the spatial orientation of the aperture of the audiovisual system for receiving media, and also the screen of the audiovisual system, have been independently selected respectively during the first-orienting and during the second-orienting nonetheless to the particular front, rear, side, top or bottom surface of the passenger compartment of the vehicle to which the audiovisual system is mounted.

10. A assembly method according to claim 9 wherein the collectively securing comprises:
bolting.
